(19) United States
(12) Patent Application Publication
(10) Pub. No.: US 2013/0011553 A1
(43) Pub. Date: Jan. 10, 2013

(54) PROCESSES FOR PREPARING COATED PRINTING PAPER

(75) Inventors: Riichi Muramatsu, Tokyo (JP); Koji Okomori, Tokyo (JP); Masanori Kawashima, Tokyo (JP); Masashi Okamoto, Tokyo (JP); Keisuke Tagami, Tokyo (JP); Shu Arahi, Tokyo (JP)

(73) Assignee: NIPPON PAPER INDUSTRIES CO., LTD., Tokyo (JP)

(21) Appl. No.: 13/635,800

(22) PCT Filed: Mar. 29, 2011
(86) PCT No.: PCT/JP2011/057746

§ 371 Date: Sep. 18, 2012

(30) Foreign Application Priority Data
Mar. 30, 2010 (JP) 077607/2010

(51) Int. Cl. B41C 1/00

(52) U.S. Cl. 427/209; 427/421.1

(57) ABSTRACT

Herein provided are processes for preparing coated printing paper having good print quality by spray coating. Specifically, a coated printing paper is prepared by a process for preparing a coated printing paper having one or more coating layers on at least one side of a base paper, comprising the steps of: preparing a spray coating solution containing a pigment and an binder including a starch, wherein (a) the starch is present at 30-100% by weight of the total amount of the binder, and (b) the Brookfield viscosity measured at 30° C., 100 rpm is 300 mPa·s or less; and applying the coating solution by spray coating to form the outermost coating layer.

### TECHNICAL FIELD

The present invention relates to processes for preparing coated printing paper having good print quality by spray coating.

### BACKGROUND ART

Generally, coated printing papers are prepared by applying a pigment coating solution based on a pigment and a binder on a base paper and then drying it, and classified into cast-coated paper, art paper, coated paper, lightweight coated paper, etc. depending on the coating mass of the coating solution or the finishing method of the coated web. These coated printing papers are subjected to printing in multiple colors or a single color and widely used as commercial prints such as advertising leaflets, pamphlets, posters, etc., or publications such as books, magazines, etc. With the recent penetration of color offset printing, even more importance has been attached to print quality such as print appearance or print gloss of coated printing papers than before.

Methods for applying a pigment coating solution on a base paper typically include blade coating and roll transfer coating. Blade coating allows coating layers to be evenly applied on paper, thereby producing coated papers having high smoothness and high sheet gloss. However, blade coating requires a high coating mass to completely cover fibers of the base paper because it is a coating method in which a coating solution is forced into the base paper as it passes under a blade so that irregularities of the surface of the base paper are smoothed. Especially when a coating layer is formed in contact with the base paper, an excessive amount of the coating solution is applied, which is unfavorable for reducing paper weight. Further, streaks or web breaks are induced by the contact between the base paper and the blade. Roll transfer coating provides coating layers contouring irregularities of the surface of a base paper, thereby reducing the coating mass as compared with blade coating. However, it cannot be said that this coating method is sufficiently compatible with the recent speeding up of paper machines and coating machines because of the problem of mist generation during high speed coating. Moreover, it is difficult to sufficiently cover the base paper when the coating mass is low.

Under such circumstances, spray coating was recently proposed as a new coating method in the field of paper pulp. Spray coating is a method for coating a paper by spraying a coating solution on the surface of the paper from a fluid nozzle known as airless spray, for example. This method is characterized by low load on the base paper during coating because no contact occurs between the base paper and the coating head. Therefore, it allows high speed coating as compared with conventional coating methods and provides good runnability without problems caused by the contact between the base paper and the coating head. This method also allows the base paper to be covered at a lower coating mass as compared with blade coating and roll transfer coating because it is a type of contour coating method. Thus, spray coating provides more efficient coating than conventional methods.

However, it can hardly be said that spray coating has been thoroughly investigated for use in processes for preparing coated papers because the coating surface is formed to contour irregularities of the surface of the base paper so that print quality such as print appearance is lower than obtained by blade coating or roll transfer coating. For example, a process for preparing a coated paper for offset printing having high sheet gloss and low air permeability by applying one or more coating layers solely by spray coating has been disclosed (see patent document 1), but the poor appearance after printing due to irregularities of the base paper cannot be improved by this method alone even though high sheet gloss can be attained by calendering or the like.

Moreover, spray coating requires a coating solution having a low viscosity because the coating solution is delivered from a small spray nozzle. For example, patent document 1 indicates that it is preferable to use water-dispersive latexes as binders while minimizing the use of water-soluble binders such as starch in order to ensure flowability of the coating solution and gloss. Thus, latexes have been typically used as binders in coating solutions of conventional spray coating. However, such a coating solution has low water retention and sinks into the base paper to result in low coverage, therefore low print appearance and print gloss. If the concentration of the coating solution is lowered to reduce the viscosity, water retention of the coating solution also decreases to result in low surface coverage, therefore low print quality. Thus, spray coating has not been sufficiently optimized for applying the outermost layer.

The use of spray coating for applying the underlayer of multilayer coating has also been disclosed in patent documents 2 and 3. In these documents, spray coating techniques capable of providing good coverage are employed for applying the underlayer in order to prevent penetration of the top layer. However, the methods described in these patent documents cannot be said to take advantage of non-contact spray coating techniques because they have problems such as the machine speed limited by using contact-type coating methods such as blade coating for applying the top layer as well as problems caused by the contact between the blade and the base paper.

Thus, it was very difficult to combine high speed coating, high runnability and good print quality by conventional spray coating techniques.

### CITATION LIST

### Patent Documents

Patent document 1: JP 2005-68614 A

Patent document 2: JP 2007-10023 A

Patent document 3: JP 2008-179915 A

### SUMMERY OF INVENTION

### Technical Problem

Under these circumstances, an object of the present invention is to prepare coated printing paper having good print quality by spray coating.

### Solution to Problem

As a result of careful studies, we achieved the present invention on the basis of the finding that the above problems can be solved by controlling the viscosity in an appropriate range while incorporating a high proportion of a starch as a binder to obtain good print quality in pigment coating by spray coating.

Accordingly, the above problems can be solved by a process for preparing a coated printing paper having one or more coating layers on at least one side of a base paper according to the present invention, comprising the steps of:
preparing a spray coating solution containing a pigment and a binder including a starch, wherein (a) the starch is present at 30-100% by weight of the total amount of the binder, and (b) the Brookfield viscosity measured at 30° C., 100 rpm is 300 mPa·s or less; and applying the coating solution by spray coating to form the outermost coating layer.

### Advantageous Effects of Invention

According to the present invention, a process for preparing a coated printing paper having good quality such as print gloss, print appearance or the like by using spray coating can be provided. According to the present invention, high speed coating can also be achieved, whereby productivity can be improved and production cost can be reduced.

### DESCRIPTION OF EMBODIMENTS

The present invention proposes preparing a spray coating solution containing a pigment and a binder including a starch, wherein (a) the starch is present at 30-100% by weight of the total amount of the binder, and (b) the Brookfield viscosity measured at 30° C., 100 rpm is 300 mPa·s or less, and applying the coating solution by spray coating to form the outermost coating layer. In the present invention, a process for preparing a coated printing paper by spray coating can be provided, which promotes spreading of the coating solution on the base paper to avoid uneven coating by incorporating a starch into the coating solution to improve water retention of the coating solution in contrast to conventional techniques that excluded the use of starches responsible for increase in viscosity, while the concentration is adjusted to an optimal value by primarily using calcium carbonate as a pigment to prevent excessive increase in viscosity, whereby high-speed coating, high runnability and good print quality are combined.

### [Spray Coating Layers]

In the present invention, the outermost coating layer among coating layers formed on a base paper is formed by spray coating. The outermost coating layer is the coating layer farthest away from the base paper, and hereinafter sometimes simply referred to as outermost layer. When a single coating layer is formed by spray coating, this coating layer constitutes the outermost coating layer. The other coating layers may be formed by methods other than spray coating, but high runnability is achieved when all the coating layers are formed by spray coating. Unless otherwise specified, the term “spray coating layer” as used herein refers to the outermost coating layer.

### [Spray Coating]

Spray coating is excellent in coatability at high speed so that coated papers can be produced very efficiently. A preferred range of coating speed is 1000-3000 m/min, more preferably 1300m-3000 m/min, still more preferably 1500-3000 m/min. At the coating speed of 1000 m/min or more, more preferably 1500 m/min or more, smoothness improves because the pigment in the coating solution is readily oriented along the surface of a paper web conveyed at high speed when the coating solution collides with the paper web. Moreover, this impact helps the coating solution to spread out, thereby improving coverage of the base paper.

Spray coating may be performed either on-machine or off-machine. Both air spray nozzles and airless spray nozzles can be used, among which airless spray nozzles allow coating solutions to be delivered under pressure at high speed so that fine particles of the coating solutions can be formed by the shear stress produced by the contact between coating films and the atmosphere and liquid drops can be spread out on the surface of paper in a satisfactory state. Moreover, airless spray nozzles are preferred because contamination of nozzle tips can be reduced. In order to form an evener coating layer surface to improve quality such as sheet appearance or print appearance, spray coating should preferably take place under the following conditions. The pressure at which a coating solution is delivered from a spray nozzle is preferably 5 MPa (50 bar) or more. The upper limit of the pressure is preferably 20 MPa (200 bar) or less. The diameter (inner diameter) of the spray nozzle is preferably 0.20-0.60 μm, more preferably 0.30-0.60 μm. If the diameter is less than the lower limit, the coating solution is hard to deliver, but if the diameter exceeds the upper limit, the coating solution tends to drip. Print appearance improves when using a nozzle having a smaller diameter under a higher delivery pressure as compared with a nozzle having a larger diameter under a lower delivery pressure at an equivalent coating mass. Print appearance further improves especially when a coating solution having a solids content of 60% by weight or less is applied by spray coating at the pressure specified above using the nozzle specified above. Coating is preferably performed with multiple spray nozzles placed at a distance from each other, in which case a preferable distance between each nozzle tip and the paper surface is 90-110 mm. Outside this range, it is difficult to obtain a good coating layer surface because the following problems tend to occur: uncoated areas tend to remain or jets of the coating solution from adjacent nozzles interfere with each other.

The coating mass of the coating layer formed by spray coating and dried (hereinafter sometimes referred to as “spray coating layer”) is preferably more than 3.0 g/m², more preferably 6.0 g/m² or more per side. Coating masses of 3.0 g/m² or less are not preferred because the appearance of the coated paper deteriorates. On the other hand, the coating mass is preferably 15.0 g/m² or less, more preferably 12.0 g/m² or less. Coating masses of more than 15.0 g/m² are not preferred because the paper weight increases.

### [Pigments in the Spray Coating Solution]

Pigments that can be used in coating layers of the present invention include those conventionally used as coating pigments for paper. The classes of these pigments include inorganic pigments such as ground calcium carbonate, precipitated calcium carbonate, clay, kaolin, talc, titanium dioxide, barium sulfate, calcium sulfate, zinc oxide, silicic acid, silicates, colloidal silica and satin white; and organic pigments such as plastic pigments.

In view of the low viscosity of the resulting coating solution and the production cost, it is preferable to primarily use calcium carbonate, more preferably ground calcium carbonate. The content of ground calcium carbonate is preferably 50% by weight, more preferably 90% by weight or more, still more preferably 100% by weight of the total amount of pigments.

### [Binders in the Spray Coating Solution]

Binders used in the present invention contain a starch. Starch is a natural polymer of many a-glucose molecules linked by glycosidic bonds or a modification thereof. Starch functions to maintain water retention of the coating solution, whereby the surface of the base paper can be fully covered. Specific starches include oxidized starches, cationized starches, starch carbamate/phosphate esters, starch hydroxyethyl ethers, etc. The starch content is 30-100% by weight, preferably 50-100% by weight, more preferably 60-100% by weight of the total amount of binders. Binders containing a high proportion of a starch functioning to increase water retention of the coating solution can prevent uneven coating caused by sinking of the coating solution before spreading all over the base paper, thus improving print appearance and print gloss. As water retention of the coating solution improves, the amount of water removed from the coating solution also decreases. Thus, a preferred range of the amount of water removed is 100 ml or less. If the starch content is less than 30% by weight, however, coverage of the base paper decreases because water retention of the coating solution decreases.

Binders that can be used other than starches include those conventionally used for coated papers. These binders include synthetic binders such as various copolymers including styrene-butadiene copolymers, styrene-acrylic copolymers, ethylene-vinyl acetate copolymers, butadiene-methyl methacrylate copolymers and vinyl acetate-butyl acrylate copolymers, or polyvinyl alcohols, maleic anhydride copolymers and acrylic-methyl methacrylate copolymers; proteins such as casein, soybean protein and synthetic proteins; and cellulose derivatives such as carboxymethyl cellulose, hydroxymethyl cellulose and hydroxyethyl cellulose, and one or more of them may be used in combination.

In the present invention, the total amount of binders in spray coating layers is preferably 5-30 parts by weight, more preferably 5 parts by weight or more and less than 20 parts by weight per 100 parts by weight of pigments. If the total amount of binders exceeds 30 parts by weight, the viscosity of the coating solution increases to hinder the coating solution from flowing through pipes or screens, thereby causing potential disadvantages such as runnability problems and cost increase. If the total amount of binders is 20 parts by weight or more, the proportion of pigments in the coating solution relatively decreases so that print quality unfavorably tends to decrease. If the total amount of binders is less than 5 parts by weight, it would be unfavorable because sufficient surface strength cannot be obtained. Therefore, the content of pigments in the coating solution in the present invention can be ensured by controlling the total amount of binders at a predetermined value or less in this manner. As a result, coated printing papers having remarkably improved print quality such as print appearance or print gloss and ink adhesion can be obtained as compared with those attainable by conventional spray coating techniques.

In the coating solution of the present invention, various conventional additives can be used such as dispersants, thickeners, water retention agents, antifoamers, waterproofing agents, dyes, fluorescent dyes, etc.

### [Viscosity of the Spray Coating Solution]

The coating solution used for spray coating according to the present invention has a Brookfield viscosity of 300 mPa·s or less. If the viscosity is 300 mPa·s or less, sheet appearance and print appearance of the resulting coated printing paper improve and runnability also improves. If the viscosity is higher than 300 mPa·s, sheet appearance and print appearance deteriorate because the coating solution does not sufficiently spread out on the surface of paper to cause uneven coating or the like after it collides with the paper. However, coverage decreases if the viscosity is too low, and therefore, the viscosity is preferably 30 mPa·s or more. The Brookfield viscosity of the coating solution is measured at a spinning speed of 100 rpm, 30° C. using a rotor appropriate for the viscosity.

The viscosity of the coating solution can be controlled primarily by the solids content of the coating solution. In the present invention, the solids content is preferably 70% by weight or less, more preferably 60% by weight or less, still more preferably 50% by weight or less. In view of the quality of the resulting coated paper, the solids content is preferably 30% by weight or more. The solids content is determined from the amount of solids obtained when the coating solution is dried.

### [Base Paper]

The base paper used in the present invention comprises pulp, fillers and various additives. Pulps that can be used include, but are not specifically limited to, chemical pulps, semi-chemical pulps, mechanical pulps, waste paper pulps or the like, and these can be appropriately used for intended purposes.

Fillers that can be used in the base paper include known fillers such as precipitated calcium carbonate, ground calcium carbonate, talc, kaolin, clay, silica, amorphous silicates, titanium oxide, synthetic resin fillers, precipitated calcium carbonate-silica complexes, etc. The amount of the fillers added to the base paper is not specifically limited, but can be about 3-40% by weight based on the dry weight of pulp.

These stocks can be converted into paper with the addition of chemicals typically used in papermaking processes such as paper strength enhancers, sizing agents, antifoaming agents, colorants, bulking agents, softening agents and the like as appropriate so far as the benefits of the present invention are not affected.

The base paper may be prepared by any process including, but not specifically limited to, acidic, neutral or alkaline process using a Fourdrinier paper machine including a top wire or the like, a cylinder paper machine or a gap former machine. A base paper precoated with starch, polyvinyl alcohol or the like using a size press, gate roll coater, bill blade or the like can also be used.

Coating base papers that can be used include those having a basis weight of about 25-400 g/m²as used for conventional coated papers. In view of the balance between weight reduction and quality, the coating base papers preferably have a basis weight of 30-180 g/m², more preferably 30-80 g/m².

### [Drying of Spray Coating Layers]

In the present invention, a wet coating layer is formed by spray coating on a base paper or a coating layer provided on a base paper. The wet coating layer is dried by using a conventional means such as a steam heater, gas heater, infrared heater, electric heater, hot air heater, microwave, cylinder dryer or the like, for example.

### [Calendering]

Coated printing papers prepared by the present invention may be smoothed by calendering using a supercalender, hot soft nip calender or the like.

### [Ash Content and Density of Coated Printing Papers]

The ash content and density of coated printing papers obtained by the present invention are not specifically limited, but may be in the range of those of conventional coated printing papers.

### EXAMPLES

The following examples further illustrate the present invention without, however, limiting the invention thereto. Unless otherwise specified, parts and % in the examples refer to parts by weight and % by weight, respectively. The resulting coated printing papers were evaluated according to the methods shown below.

### (Evaluation Methods)

(1) Print appearance: Printing was performed in a Roland sheet-fed Offset Press (4 colors) at a printing speed of 8000 sheets/hr using lithographic printing inks (Hy-Unity M from Toyo Ink Mfg. Co., Ltd.) in the order of cyan→magenta→yellow→black, and the resulting print was visually evaluated for print appearance (uneven ink adhesion, uneven gloss, etc.) especially in the solid print area and halftone (50%) print area in the four colors and cyan alone: ⊚: very good, ◯: good, Δ: slightly poor, ×: poor.
(2) Print gloss: measured according to JIS P 8142 on the surface of the resulting print in the solid print area in the four colors.
(3) Delta gloss: The difference between the sheet gloss measured according to JIS P 8142 and the print gloss was determined.
(4) Runnability: evaluated from runnability during coating, the incidence of problems such as web breaks or streaks, productivity, etc., according to the following standards: ⊚: very good, ◯: good, Δ: slightly poor, ×: poor.
(5) Analysis of dynamic water retention: measured under conditions of 30° C., pressure 0.5 bar, 40 sec, sample volume 20 ml, using an instrument known as Water Retention Meter from Kaltec Scientific, Inc. together with the recommended film (filter) “AA-GWR Test Filters (Kaltec Scientific, Inc.), GWR420”. The smaller this value, the higher the dynamic water retention.

### Example 1

### Preparation of Spray Coating Solution 1

To 100 parts of a ground calcium carbonate slurry (FMT-90 from FIMATEC Ltd.) as a pigment were added 6 parts of an alkali-thickenable styrene-butadiene copolymer latex (glass transition temperature: −20° C., gel content: 85%) and 4 parts of a hydroxyethylated starch (Ethylex 2005 from Sanwa Cornstarch Co., Ltd.) as binders followed by water to give spray coating solution 1 having a solids content of 50%. The Brookfield viscosity of this coating solution was 30 mPa·s.

The coating base paper used was a woodfree paper containing 7%, based on the weight of the base paper, of precipitated calcium carbonate as a filler and 100% of chemical pulp as papermaking pulp and having a basis weight of 40 g/m² and a density of 0.7 g/cm³.

The spray coating solution 1 described above was applied on both sides of the base paper described above at a coating mass of 7 g/m² per side using an airless spray coater (coating conditions: spray pressure conditions: 8 MPa (80 bar), distance between nozzles: 60 mm, distance between nozzles and paper: 100 mm, nozzle diameter: 0.5 μm) at a coating speed of 1500 m/min and then the resulting coated web was dried to a moisture content of 6%.

After drying, the coated web was passed through a hot soft nip calender to give a coated printing paper.

### Example 2

A coated printing paper was obtained in the same manner as in Example 1 except that a coating solution was prepared by adding 6 parts of the hydroxyethylated starch (Ethylex 2005 from Sanwa Cornstarch Co., Ltd.) in spray coating solution 1. The Brookfield viscosity of this coating solution was 50 mPa·s.

### Example 3

A coated printing paper was obtained in the same manner as in Example 1 except that a coating solution was prepared by adding 4 parts of the alkali-thickenable styrene-butadiene copolymer latex (glass transition temperature: −20° C., gel content: 85%) and 8 parts of the hydroxyethylated starch (Ethylex 2005 from Sanwa Cornstarch Co., Ltd.) in spray coating solution 1. The Brookfield viscosity of this coating solution was 90 mPa·s.

### Example 4

A coated printing paper was obtained in the same manner as in Example 1 except that a coating solution was prepared by adding 16 parts of the hydroxyethylated starch (Ethylex 2005 from Sanwa Cornstarch Co., Ltd.) as a sole binder in spray coating solution 1. The Brookfield viscosity of this coating solution was 300 mPa·s.

### Example 5

A coated printing paper was obtained in the same manner as in Example 1 except that a coating solution was prepared by adjusting the solids content to 48% in spray coating solution 1. The Brookfield viscosity of this coating solution was 8 mPa·s.

### Example 6

A coated printing paper was obtained in the same manner as in Example 1 except that a coating solution was prepared by adjusting the solids content to 55% in spray coating solution 1. The Brookfield viscosity of this coating solution was 80 mPa·s.

### Example 7

A coated printing paper was obtained in the same manner as in Example 1 except that a coating solution was prepared by adjusting the solids content to 60% in spray coating solution 1. The Brookfield viscosity of this coating solution was 300 mPa·s.

### Example 8

A coated paper was obtained in the same manner as in Example 3 except that the spray pressure conditions were adjusted to 5 MPa (50 bar) to provide a coating mass of 3 g/m² per side.

### Example 9

A coated paper was obtained in the same manner as in Example 1 except that the nozzle diameter of the airless spray coater was 0.3 μm and the spray pressure conditions were adjusted to 12 MPa (120 bar).

### Example 10

A coated printing paper was obtained in the same manner as in Example 6 except that 75 parts of the ground calcium carbonate slurry (FMT-90 from FIMATEC Ltd.) and 25 parts of fine-grained clay (HYDRAGLOSS from KaMin) were used as pigments in the coating solution prepared in Example 6. The Brookfield viscosity of this coating solution was 90 mPa·s.

### Example 11

A coated printing paper was obtained in the same manner as in Example 1 except that a coating solution was prepared by adding 12 parts of the alkali-thickenable styrene-butadiene copolymer latex (glass transition temperature: −20° C., gel content: 85%) and 8 parts of the hydroxyethylated starch (Ethylex 2005 from Sanwa Cornstarch Co., Ltd.) as binders in spray coating solution 1. The Brookfield viscosity of this coating solution was 120 mPa·s.

### Comparative Example 1

A coated printing paper was obtained in the same manner as in Example 1 except that a coating solution was prepared by adding 8 parts of the alkali-thickenable styrene-butadiene copolymer latex (glass transition temperature: −20° C., gel content: 85%) as a sole binder in spray coating solution 1. The Brookfield viscosity of this coating solution was 10 mPa·s.

### Comparative Example 2

A coated printing paper was obtained in the same manner as in Example 1 except that a coating solution was prepared by adding 8 parts of the alkali-thickenable styrene-butadiene copolymer latex (glass transition temperature: −20° C., gel content: 85%) as a sole binder and adjusting the solids content to 60% in spray coating solution 1. The Brookfield viscosity of this coating solution was 60 mPa·s.

### Comparative Example 3

A coated printing paper was obtained in the same manner as in Example 1 except that a coating solution was prepared by adjusting the solids content to 65% in spray coating solution 1. The Brookfield viscosity of this coating solution was 1000 mPa·s.

### Comparative Example 4

A coated printing paper was obtained in the same manner as in Example 1 except that a coating solution was prepared by adjusting the solids content to 65% in spray coating solution 1 and applied by blade coating. The Brookfield viscosity of this coating solution was 1000 mPa·s.

### Comparative Example 5

A coated printing paper was obtained in the same manner as in Example 1 except that a coating solution was prepared by adjusting the solids content to 63% in spray coating solution 1 and applied by gate roll coating (GRC). The Brookfield viscosity of this coating solution was 750 mPa·s.

The evaluation results are shown in Table 1-1 and Table 1-2.

TABLE 1-1

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 1 | ple 2 | ple 3 | ple 4 | ple 5 | ple 6 | ple 7 | ple 8 | ple 9 | ple 10 | ple 11 |
| | Coating method | Spray | Spray | Spray | Spray | Spray | Spray | Spray | Spray | Spray | Spray | Spray |
| Coating | Proportion of | 40 | 50 | 66.7 | 100 | 40 | 40 | 40 | 66.7 | 40 | 40 | 40 |
| solution | starch to the | | | | | | | | | | | |
| | total amount | | | | | | | | | | | |
| | of binders | | | | | | | | | | | |
| | (% by weight) | | | | | | | | | | | |
| | Total binders | 10 | 12 | 12 | 16 | 10 | 10 | 10 | 12 | 10 | 10 | 20 |
| | Solids content | 50 | 50 | 50 | 50 | 48 | 55 | 60 | 50 | 50 | 55 | 50 |
| | (% by weight) | | | | | | | | | | | |
| | Brookfield | 30 | 50 | 90 | 300 | 8 | 80 | 300 | 90 | 30 | 90 | 120 |
| | viscosity | | | | | | | | | | | |
| | (mPa · s) | | | | | | | | | | | |
| | Amount of water | 81 | 70 | 67 | 51 | 100 | 75 | 68 | 67 | 81 | 72 | 60 |
| | removed (ml) | | | | | | | | | | | |
| | Coating mass | 7 | 7 | 7 | 7 | 7 | 7 | 7 | 3 | 7 | 7 | 7 |
| | per side (g/m²) | | | | | | | | | | | |
| Evaluation | Print appearance | ⊚ | ⊚ | ⊚ | ⊚ | ⊚ | ⊚ | ⊚ | ◯ | ⊚ | ◯ | Δ |
| results | Print gloss | 65 | 65 | 65 | 65 | 62 | 63 | 60 | 55 | 67 | 63 | 60 |
| | Delta gloss | 25 | 28 | 30 | 35 | 25 | 25 | 25 | 23 | 28 | 21 | 25 |

| | | | | | | | | | | | |
|---|---|---|---|---|---|---|---|---|---|---|---|
| Runnability | ⊚ | ⊚ | ⊚ | ⊚ | ⊚ | ⊚ | ⊚ | ⊚ | ⊚ | ⊚ | ⊚ |

TABLE 1-2

| | | Comparative | Comparative | Comparative | Comparative | Comparative |
|---|---|---|---|---|---|---|
| | | example 1 | example 2 | example 3 | example 4 | example 5 |
| | Coating method | Spray | Spray | Spray | Blade | GRC |
| Coating | Proportion of | 0 | 0 | 40 | 40 | 40 |
| solution | starch to the total | | | | | |
| | amount of binders | | | | | |
| | (% by weight) | | | | | |
| | Total binders | 8 | 8 | 10 | 10 | 10 |
| | Solids content | 50 | 60 | 65 | 65 | 63 |
| | (% by weight) | | | | | |
| | Brookfield | 10 | 60 | 1000 | 1000 | 750 |
| | viscosity | | | | | |
| | (mPa · s) | | | | | |
| | Amount of water | 199 | 172 | 46 | 46 | 51 |
| | removed (ml) | | | | | |
| | Coating mass per | 7 | 7 | 7 | 7 | 7 |
| | side (g/m²) | | | | | |
| Evaluation | Print appearance | X | X | X | ⊚ | ⊚ |
| results | Print gloss | 45 | 50 | 55 | 70 | 65 |
| | Delta gloss | 10 | 10 | 30 | 30 | 28 |

| | | | | | |
|---|---|---|---|---|---|
| Runnability | ⊚ | ⊚ | ⊚ | Δ | X |

The results of Table 1-1 show that coated printing papers having excellent print appearance and high print gloss can be prepared by spray coating in Examples 1-10. Especially when the starch content is high, delta gloss tends to increase, as shown in Examples 2-4. On the other hand, the results of Example 8 show that when the coating mass is low, print appearance tends to be slightly poor. Example 9 showed improved print appearance, print gloss and delta gloss because smaller particles were delivered from the nozzles having a smaller diameter.

The coating solution used in Example 10 containing clay as a pigment had a slightly higher viscosity than that of the coating solution of Example 6 containing no clay, and the resulting coated paper showed a tendency to have slightly lower print appearance and delta gloss. Example 11 showed a tendency to provide excellent runnability but slightly lower print appearance. It is supposed that this may be attributed to the relative decrease of the proportion of the pigment to the increased total amount of the binders.

The results of Table 1-2 show that the coating solutions containing no starch used in Comparative examples 1 and 2 had too low water retention to cover the base paper, resulting in poor print appearance. In Comparative example 3, the base paper was not covered and print appearance was poor because the Brookfield viscosity was so high that the coating solution was not sufficiently dispersed when the coating solution was delivered from the spray nozzles even though starch was contained. In Comparative examples 4 and 5, runnability decreased.

1. A process for preparing a coated printing paper having one or more coating layers on one side or both sides of a base paper, comprising the steps of:
preparing a spray coating solution containing a pigment and a binder including a starch, wherein (a) the starch is present at 30-100% by weight of the total amount of the binder, and (b) the Brookfield viscosity measured at 30° C., 100 rpm is 300 mPa·s or less; and
applying the coating solution by spray coating to form the outermost coating layer.

2. The process of claim 1 wherein the content of the binder is 5 parts by weight or more and less than 20 parts by weight per 100 parts by weight of the pigment.

3. The process of claim 1 wherein the content of the starch is 50-100% by weight of the total amount of the binder.

4. The process of claim 1 wherein the solids content of the spray coating solution is 60% by weight or less.

5. The process of claim 1 wherein the coating mass of the outermost coating layer is 6 g/m² or more per side.

6. The process of claim 1 wherein the pigment includes ground calcium carbonate at 90% by weight or more of the total amount of the pigment.

7. The process of claim 1 wherein the coating speed in the spray coating is 1500 m/min or more.

8. The process of claim 1 wherein the spray coating is performed by using a nozzle having a diameter of 0.20-0.60 μm under conditions of a pressure of 5 MPa or more at which the coating solution is delivered.
